(19) United States
(12) Patent Application Publication
(10) Pub. No.: US 2013/0149051 A1
(43) Pub. Date: Jun. 13, 2013

(54) GROOVE CUTTER ASSEMBLY AND METHOD FOR FABRICATING SAME

(71) Applicant: MING LI, Shenzhen (CN)

(72) Inventor: MING LI, Shenzhen (CN)

(21) Appl. No.: 13/683,266

(22) Filed: Nov. 21, 2012

(30) Foreign Application Priority Data
Dec. 11, 2011 (CN) 201120512097.6

(51) Int. Cl. B23C 5/08; B23P 15/34

(52) U.S. Cl. CPC B23C 5/08; B23P 15/34
USPC 407/30; 76/115

(57) ABSTRACT

A groove cutter assembly includes a cutter blade and two washers. A shaft through hole is defined in a center of the cutter blade. The cutter blade includes two side surfaces. An engaging groove is defined in each of the two side surfaces around the shaft through hole in the cutter blade. A cutting edge is formed in a distal edge the cutter blade. A shaft through hole is defined in each of the two washers. Each of the two washers is securely engaged in one of the two engaging grooves of the cutter blade.

### BACKGROUND

1. Technical Field

The present disclosure generally relates to a cutter and a method for fabricating the cutter, and especially, to a groove cutter assembly for milling a groove.

2. Description of the Related Art

The conventional groove cutter includes a cutter blade. The cutter blade is thin and has a large outer diameter. When milling a groove in an object, the cutter blade is easily shaken, and this affects the accuracy and stability of the milling process, negatively. The structure strength of the cutter blade is relatively low, and therefore, the cutter blade may deform easily, such that the installation error of the groove cutter is high. In addition, a damage of the cutter blade can occur, thereby making the cutter unusable at times.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded, isometric view of an embodiment of a cutter assembly.

FIG. 2 is an assembled, isometric view of the cutter assembly of FIG. 1.

FIG. 3 is a side view of the cutter assembly of FIG. 2.

FIG. 4 is an isometric view of an embodiment of a cutter blade preform.

### DETAILED DESCRIPTION

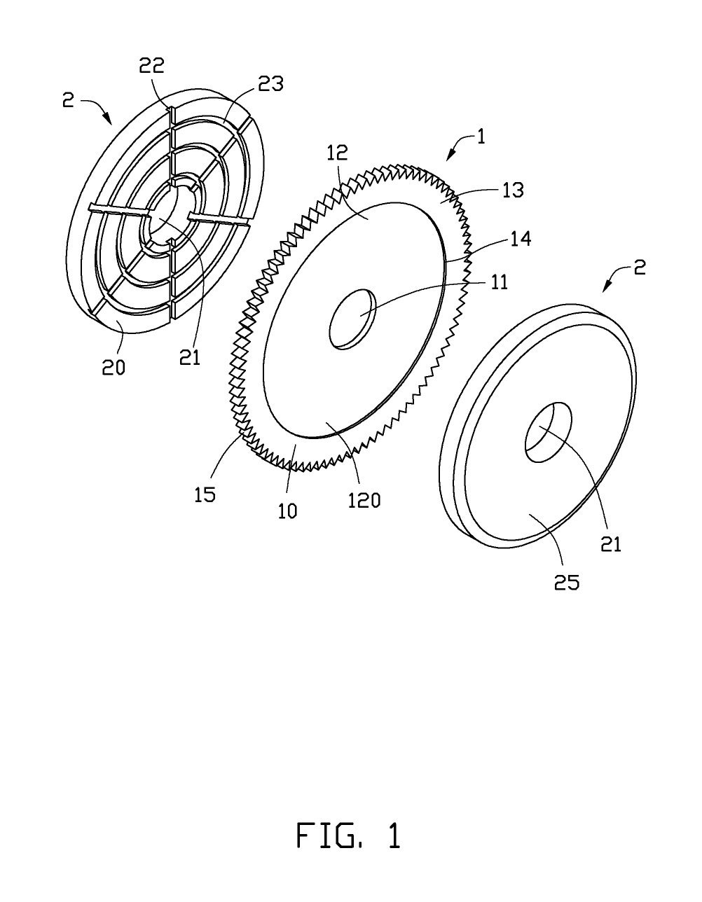

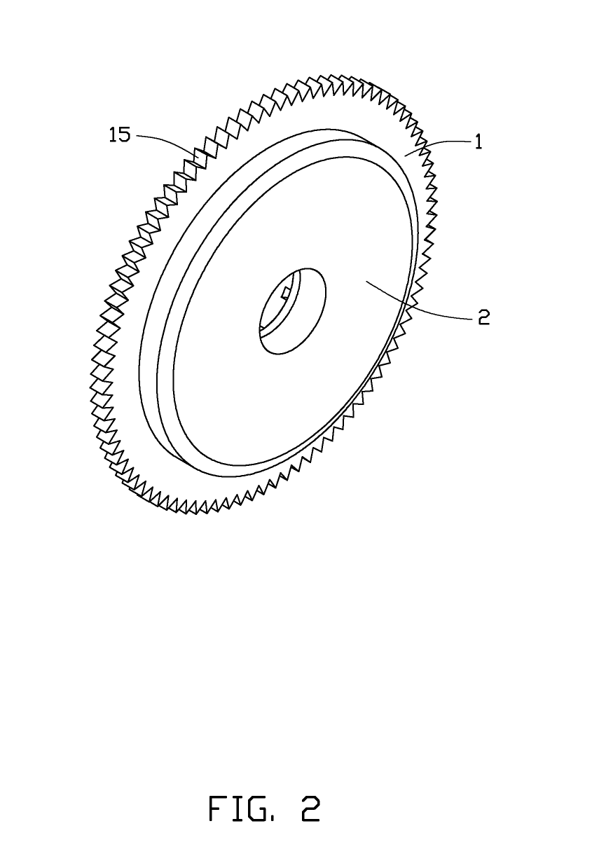

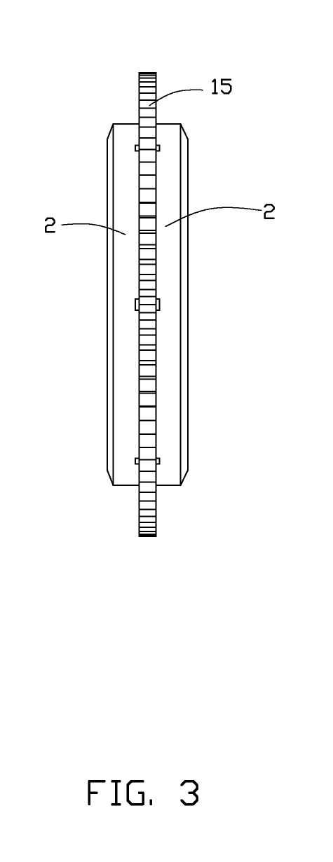

FIGS. 1 through 3 show an embodiment of a groove cutter assembly 100. The groove cutter assembly 100 includes a cutter blade 1 and two washers 2. The cutter blade 1 is made of tungsten steel. The washers 2 are made of JIS S45C/S48C steel.

The cutter blade 1 includes two side surfaces 10. A shaft through hole 11 is defined in a center of the cutter blade 1. A diameter of the shaft through hole 11 is greater than or equal to a diameter of a driving shaft (not shown). An engaging groove 120 is defined in each side surface 10 configured around the shaft through hole 11. The engaging groove 120 is substantially annular, such that the side surface 10 forms an inner annular area 12 and an outer annular area 13. A thickness of the inner annular area 12 is smaller than a thickness of the outer annular area 13. A connecting surface 14 is formed between the inner annular area 12 and the outer annular area 13. A cutting edge 15 is formed in a distal edge of the outer annular area 13.

Each washer 2 includes an inner surface 20 and an outer surface 25 opposite to the inner surface 20. A shaft through hole 21 is defined in a center of each washer 2. A plurality of radial grooves 22 and a plurality of annular grooves 23 are defined in the inner surface 20. The radial grooves 22 extend along the radial directions of the washer 2. The annular grooves 23 are communicated with the radial grooves 22, and are configured around the shaft through hole 21. The washers 2 are engaged in the engaging grooves 120 in two sides of the cutter blade 1, respectively, and the inner surface 20 of the washer 2 is attached to the inner annular area 12 of the cutter blade 1. In use, the groove cutter assembly 100 is sleeved on the driving shaft, and the shaft through holes 21 of the washers 2 are engaged with the driving shaft.

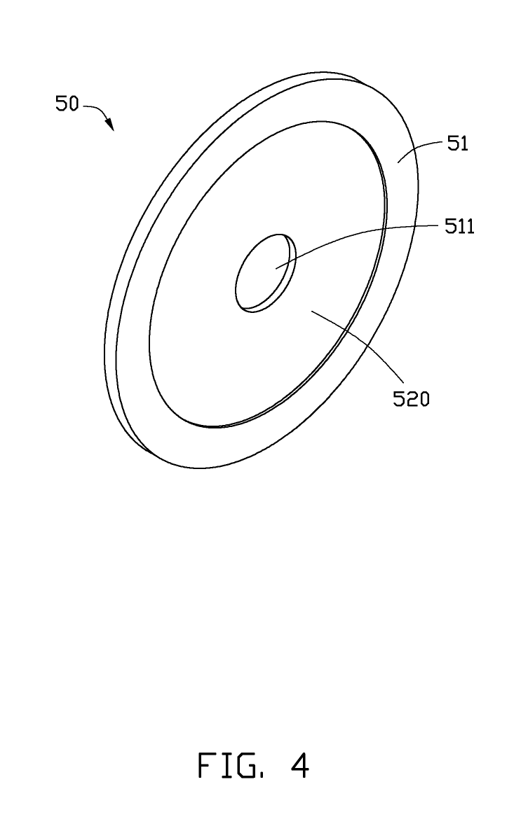

Also referring to FIG. 4, a method of fabricating the groove cutter assembly 100 includes steps as follows:

In a first step, two washers 2 are provided. Each washer 2 includes an inner surface 20 and an outer surface 25 opposite to the inner surface 20. A shaft through hole 21 is defined in a center of each washer 2. A plurality of radial grooves 22 and a plurality of annular grooves 23 are defined in the inner surface 20 of each washer 2. The radial grooves 22 extend along the radial directions of the washer 2. The annular grooves 23 communicate with the radial grooves 22, and are located around the shaft through hole 21. The washers 2 are made of JIS S45C/S48C steel.

In a second step, a cutter blade preform 50 is provided. The cutter blade preform 50 includes two side surfaces 51. A shaft through hole 511 is defined in a center of the cutter blade preform 50. An engaging groove 520 is defined in each side surface 51 around the shaft through hole 511. The engaging groove 520 is substantially annular, and the shape thereof matches the washer 2. The cutter blade preform 50 is made of tungsten steel.

In a third step, each of the two washers 2 is securely mounted in the engaging groove 520 of each side surface 51 of the cutter blade preform 50 with adhesive or by using a copper brazing method.

In a fourth step, a cutting edge 15 is formed in a distal edge of the cutter blade preform 50 to obtain the groove cutter assembly 100.

In other alternative embodiments of instant disclosure, certain of the steps described above may be removed, while other additional steps may be added, and the order sequence of the steps may be altered or switched. It is also to be understood that the description and the claims drawn to a method may include some indication in reference to certain steps. However, the indication used is only to be viewed for identification purposes and not as a suggestion as to an order for the steps.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A groove cutter assembly, comprising:
a cutter blade defining a shaft through hole in a center thereof, and the cutter blade comprising two side surfaces, wherein an engaging groove is defined in each of the two side surfaces around the shaft through hole, and a cutting edge is formed in a distal edge of the outer edge of the cutter blade; and
two washers, wherein a shaft through hole is defined in each of the two washers, and each of the two washers is securely engaged in one of the two engaging grooves of the cutter blade.

2. The groove cutter assembly of claim 1, wherein the washer comprises an inner surface attached to the cutter blade; a plurality of radial grooves is defined in the inner surface of the washer, and the radial grooves extend along radial directions of the washer.

3. The groove cutter assembly of claim 2, wherein a plurality of annular grooves is defined in the inner surface of the washer; the annular grooves communicate with the radial grooves.

4. The groove cutter assembly of claim 1, wherein the cutter blade is made of tungsten steel.

5. The groove cutter assembly of claim 1, wherein the washer is made of JIS S45C/S48C steel.

6. A method for fabricating a groove cutter assembly, comprising:
providing two washers, wherein a shaft through hole is defined in each of the two washers;
providing a cutter blade preform defining a shaft through hole in a center thereof and comprising two side surfaces, wherein an engaging groove is defined in each of the two side surfaces around the shaft through hole;
securely mounting each of the two washers in the engaging groove of each side surface of the cutter blade preform with adhesive or using a copper brazing method; and
forming a cutting edge in a distal edge of the cutter blade preform to obtain the groove cutter assembly.

7. The method of claim 6, wherein the washer comprises an inner surface attached to the cutter blade; a plurality of radial grooves is defined in the inner surface of the washer, and the radial grooves extend along a radial direction of the washer.

8. The method of claim 7, wherein a plurality of annular grooves is defined in the inner surface of each of the washers; the annular grooves communicate with the radial grooves.

9. The method of claim 6, wherein the cutter blade is made of tungsten steel.

10. The method of claim 6, wherein the washer is made of JIS S45C/S48C steel.
